(19) United States
(12) Patent Application Publication
(10) Pub. No.: US 2023/0195667 A1
(43) Pub. Date: Jun. 22, 2023

(54) CHIPLET SYSTEM WITH AUTO-SWAPPING, AND SIGNAL COMMUNICATION METHOD THEREOF

(71) Applicant: Sunplus Technology Co., Ltd., Hsinchu (TW)

(72) Inventors: Hsing-Sheng HUANG, Hsinchu City (TW); Hao-Chang CHANG, Taipei City (TW); Ming-Chang SU, Hsinchu County (TW); Hwan-Rei LEE, Hsinchu City (TW)

(21) Appl. No.: 18/070,127

(22) Filed: Nov. 28, 2022

(30) Foreign Application Priority Data
Dec. 22, 2021 (TW) 110148201

(51) Int. Cl. G06F 13/36

(52) U.S. Cl. CPC G06F 13/36; G06F 2213/40

(57) ABSTRACT

A chiplet system with an auto-swapping function and a signal communication method thereof are provided. The chiplet system at least includes a first chiplet and a second chiplet. The signal communication method includes the following steps. The first chiplet and the second chiplet are electrified. The first chiplet and the second chiplet are reset and driven. Through a serial number information, the first chiplet and the second chiplet are identified. A handshaking communication procedure is executed by the first chiplet and the second chiplet to confirm whether a pin connection relationship between the first chiplet and the second chiplet is correct. If the pin connection relationship between the first chiplet and the second chiplet is incorrect, pin function switching is performed by the first chiplet or the second chiplet.

This application claims the benefit of Taiwan application Serial No. 110148201, filed Dec. 22, 2021, the subject matter of which is incorporated herein by reference.

### BACKGROUND OF THE INVENTION

### Field of the Invention

The invention relates in general to a semiconductor device and a signal communication method thereof, and more particularly to a chiplet system with an auto-swapping function and a signal communication method thereof.

### Description of the Related Art

As various electronic products are provided one after another, the demand for high efficiency, low power consumption and multi-function chips manufactured using a high-end process is getting stronger and stronger. As the function increases, chip size also increases.

The increase in chip efficiency used to rely on the improvement in the semiconductor process. However, the closer to the physical limits of Moore's Law the size of an element is, the more difficult the miniaturization of chips becomes. To further increase product efficiency, a chiplet technology is provided. An original chip is divided into several chiplets, and the chiplets with common functions are manufactured together. For instance, basic chiplets are manufactured using a low-end semiconductor process, and high-end chiplets are manufactured using a high-end semiconductor process. Through heterogeneous integration, manufacturers of the industry can flexibly combine chiplets to form different package products, not only effectively increasing product efficiency but also increasing the yield rate of production.

### SUMMARY OF THE INVENTION

The invention is directed to a chiplet system with an auto-swapping function and a signal communication method thereof capable of confirming whether the pin connection relationship between at least two chiplets is correct through the execution of a handshaking communication procedure. If the pin connection relationship between these chiplets is incorrect, one of the chiplets automatically performs pin function switching to assure that the chiplet system can operate normally. Thus, the chiplet system can more flexibly connect these chiplets in a side-by-side or a stacked manner. Moreover, the chiplets, despite being arranged in a wrong direction the packaging process, still can operate normally, and flexibility of the packaging process can be greatly increased.

According to one embodiment of the present invention, a signal communication method of a chiplet system with an auto-swapping function is provided. The chiplet system at least includes a first chiplet and a second chiplet. The chiplet system at least includes a first chiplet and a second chiplet. The signal communication method includes the following steps. The first chiplet and the second chiplet are electrified. The first chiplet and the second chiplet are reset and driven. Through a serial number information, the first chiplet and the second chiplet are identified. A handshaking communication procedure is executed by the first chiplet and the second chiplet to confirm whether a pin connection relationship between the first chiplet and the second chiplet is correct. If the pin connection relationship between the first chiplet and the second chiplet is incorrect, pin function switching is performed by the first chiplet or the second chiplet.

According to another embodiment of the present invention, a chiplet system with an auto-swapping function is provided. The chiplet system at least includes a first chiplet and a second chiplet. The first chiplet includes a first electrification module, a first resetting-and-driving module, a first classification module and a first handshaking execution module. The first electrification module is used to perform electrification. The first resetting-and-driving module is used to perform resetting and driving. The first classification module is used to identify the first chiplet through a serial number information. The first handshaking execution module is used to execute a handshaking communication procedure. The second chiplet includes a second electrification module, a second resetting-and-driving module, a second classification module and a second handshaking execution module. The second electrification module is used to perform electrification. The second resetting-and-driving module is used to perform resetting and driving. The second classification module is used to identify the second chiplet through the serial number information. The second handshaking execution module is used to execute the handshaking communication procedure. The first chiplet and the second chiplet perform the handshaking communication procedure to confirm whether a pin connection relationship between the first chiplet and the second chiplet is correct. If the pin connection relationship between the first chiplet and the second chiplet is incorrect, the first handshaking execution module of the first chiplet or the second handshaking execution module of the second chiplet performs pin function switching.

According to an alternate embodiment of the present invention, a chiplet with an auto-swapping function is provided. The chiplet includes an electrification module, a resetting-and-driving module and a handshaking execution module. The electrification module is used to perform electrification. The resetting-and-driving module is used to perform resetting and driving. The handshaking execution module is used to execute a handshaking communication procedure. The chiplet executes the handshaking communication procedure to confirm whether a pin connection relationship between the chiplet and other chiplet is correct. If the pin connection relationship between the chiplet and other chiplet is incorrect, the handshaking execution module performs pin function switching.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1 to 2 are schematic diagrams of different chiplet systems according to different embodiments.

FIG. 3 is a schematic diagram of chiplet systems according to an embodiment.

FIG. 4 is a schematic diagram of chiplet systems according to an embodiment.

FIG. 5 is a schematic diagram of chiplet systems according to an embodiment.

FIG. 6 is a schematic diagram of chiplet systems according to an embodiment.

FIG. 7 is a block diagram of a chiplet system with auto-swapping according to an embodiment.

FIG. 8 is a flowchart of a signal communication method of a chiplet system with auto-swapping according to an embodiment.

FIG. 9 is a schematic diagram of the pins of chiplets with an auto-swapping function according to an embodiment.

FIG. 10 is a detailed flowchart of step S140 according to an embodiment.

FIG. 11 is a detailed flowchart of step S140 according to another embodiment.

FIG. 12 is a detailed flowchart of step S140 according to another embodiment.

### DETAILED DESCRIPTION OF THE INVENTION

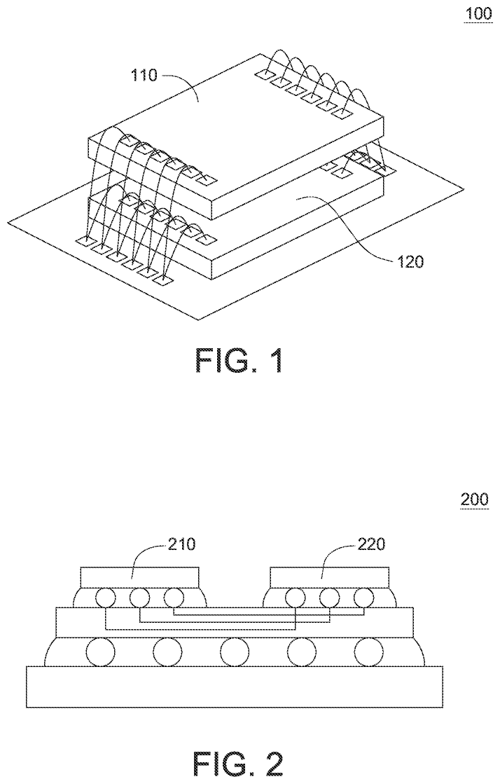

Referring to FIGS. 1 to 2, schematic diagrams of chiplet systems 100 and 200 according to different embodiments are shown. In the example of FIG. 1, the chiplets 110 and 120 of the chiplet system 100 are connected in a stacked manner. In the example of FIG. 2, the chiplets 210 and 220 of the chiplet system 200 are connected in a side-by-side manner. The chiplets 110 and 120 can be identical chiplets or different chiplets. The chiplets 210 and 220 can be identical chiplets or different chiplets. The quantity of chiplets can be increased without a limit, and the mode of connection is diversified.

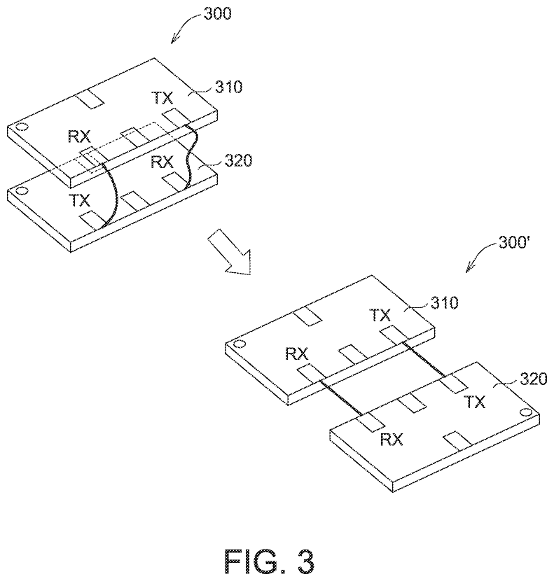

Referring to FIG. 3, a schematic diagram of chiplet systems 300 and 300′ according to an embodiment is shown. In different applications, the chiplets 310 and 320 of the chiplet system 300 need to be connected in a stacked manner; the chiplets 310 and 320 of the chiplet system 300′ need to be connected in a side-by-side manner. In the chiplet system 300, the chiplet 310 the pin TX of is correctly connected to the pin RX of the chiplet 320, and the pin RX of the chiplet 310 is correctly connected to the pin TX of the chiplet 320, therefore the pin connection relationship between the chiplets of the chiplet system 300 is correct. However, in the chiplet system 300′, the pin TX of the chiplet 310 is erroneously connected to the pin TX of the chiplet 320, and the pin RX of the chiplet 310 is erroneously connected to the pin RX of the chiplet 320, therefore the pin connection relationship between the chiplets of the chiplet system 300′ is incorrect. To correct the erroneous pin connection relationship between the chiplets of the chiplet system 300′, internal design of the chiplet 320 needs to be corrected, and the cost will be greatly increased.

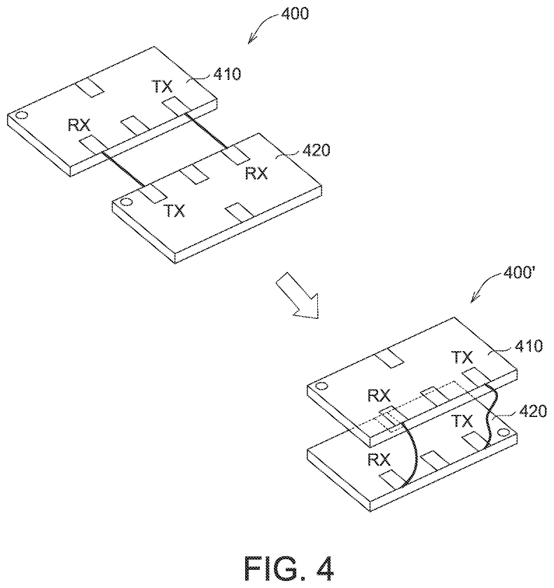

Referring to FIG. 4, a schematic diagram of chiplet systems 400 and 400′ according to an embodiment is shown. In different applications, the chiplets 410 and 420 of the chiplet system 400 need to be connected in a side-by-side manner; the chiplets 410 and 420 of the chiplet system 400′ need to be connected in a stacked manner. In the chiplet system 400, the pin TX of the chiplet 410 is correctly connected to the pin RX of the chiplet 420, and the pin RX of the chiplet 410 is correctly connected to the pin TX of the chiplet 420, therefore the pin connection relationship between the chiplets of the chiplet system 400 is correct. However, in the chiplet system 400′, the pin TX of the chiplet 410 is erroneously connected to the pin TX of the chiplet 420, and the pin RX of the chiplet 410 is erroneously connected to the pin RX of the chiplet 420, therefore the pin connection relationship between the chiplets of the chiplet system 400′ is incorrect. To correct the erroneous pin connection relationship between the chiplets of the chiplet system 400′, internal design of the chiplet 420 needs to be corrected, and the cost will be greatly increased.

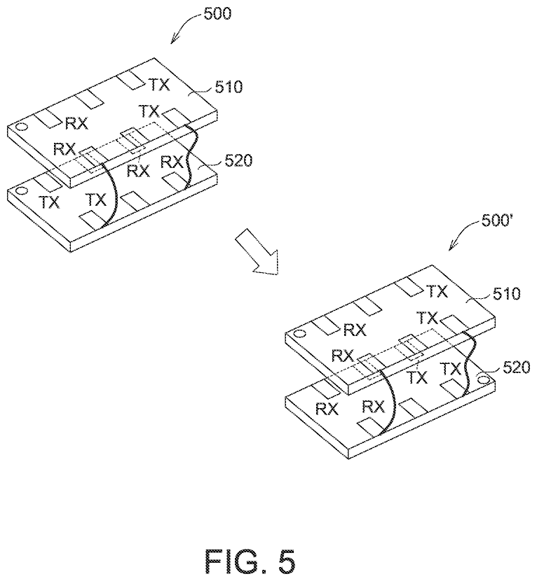

Referring to FIG. 5, a schematic diagram of chiplet systems 500 and 500′ according to an embodiment is shown. In the application of FIG. 5, the chiplets 510 and 520 of the chiplet system 500 need to be connected in a stacked manner. In the chiplet system 500, the pin TX of the chiplet 510 is correctly connected to the pin RX of the chiplet 520, the pin RX of the chiplet 510 is correctly connected to the pin TX of the chiplet 520, the pin connection relationship between the chiplets of the chiplet system 500 is correct. However, in the chiplet system 500′, the chiplet 520 is arranged in a wrong direction, causing the pin TX of the chiplet 510 to be erroneously connected to the pin TX of the chiplet 520, the pin RX of the chiplet 510 to be erroneously connected to the pin RX of the chiplet 520, the pin connection relationship between the chiplets of the chiplet system 500′ is incorrect. Since the erroneous chiplet system 500′ must be discarded and cannot be used anymore, the cost will be greatly increased.

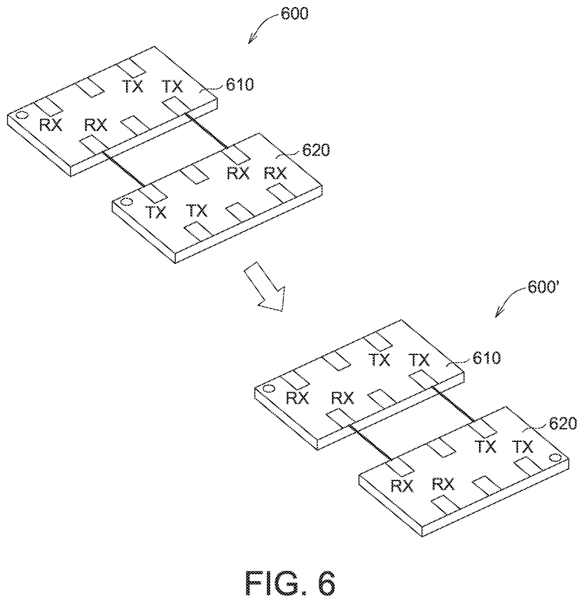

Referring to FIG. 6, a schematic diagram of chiplet systems 600 and 600′ according to an embodiment is shown. In the application of FIG. 6, the chiplets 610 and 620 of the chiplet system 600 need to be connected in a side-by-side manner. In the chiplet system 600, the pin TX of the chiplet 610 is correctly connected to the pin RX of the chiplet 620, and the pin RX of the chiplet 610 is correctly connected to the pin TX of the chiplet 620, therefore the pin connection relationship between the chiplets of the chiplet system 600 is correct. However, in the chiplet system 600′, the chiplet 620 is arranged in a wrong direction, causing the pin TX and the pin RX of the chiplet 610 to be erroneously connected to the pin TX and the pin RX of the chiplet 620 respectively, therefore the pin connection relationship between the chiplets of the chiplet system 600′ is incorrect. Since the erroneous chiplet system 600′ must be discarded and cannot be used anymore, the cost will be greatly increased.

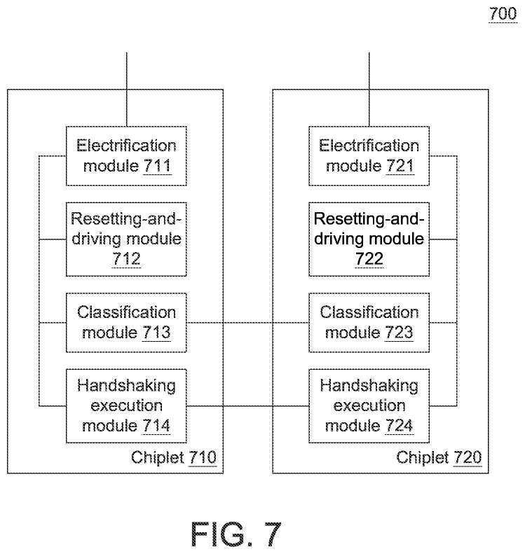

Referring to FIG. 7, a block diagram of a chiplet system with auto-swapping 700 according to an embodiment is shown. The chiplet system 700 includes a chiplet 710 and a chiplet 720. The chiplet 710 includes an electrification module 711, a resetting-and-driving module 712, a classification module 713 and a handshaking execution module 714. The electrification module 711, the resetting-and-driving module 712, the classification module 713 and the handshaking execution module 714 can be realized by a circuit or a firmware. The chiplet 720 includes an electrification module 721, a resetting-and-driving module 722, a classification module 723 and a handshaking execution module 724. The electrification module 721, the resetting-and-driving module 722, the classification module 723 and the handshaking execution module 724 can be realized by a circuit or a firmware. Brief descriptions of the functions of each element are disclosed below. The electrification modules 711 and 721 are used to perform electrification. The resetting-and-driving modules 712 and 722 are used to perform resetting and driving. The classification modules 713 and 723 are used to identify the chiplets 710 and 720. The handshaking execution modules 714 and 724 are used to execute a handshaking communication procedure. In the present embodiment, whether the connection relationship between the chiplets 710 and 720 is correct can be confirmed through the handshaking communication procedure. If the pin connection relationship between the chiplets 710 and 720 is incorrect, the chiplet 710 or the chiplet 720 will automatically perform pin function switching to assure that the chiplet system 700 can operate normally. Detailed descriptions of the operation of each element are disclosed below with an accompanying flowchart.

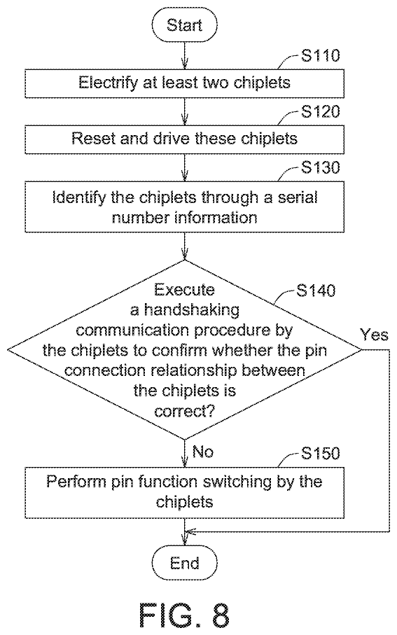

Referring to FIG. 8, a flowchart of a signal communication method of a chiplet system 700 with auto-swapping according to an embodiment is shown. Each time when the chiplet system 700 is electrified, the signal communication method of the chiplet system 700 is used to confirm whether the connection relationship between the chiplets 710 and 720 is correct to assure that the chiplet system 700 can operate normally.

In step S110, the chiplets 710 and 720 are electrified by the electrification modules 711 and 721 respectively.

Then, the method proceeds to step S120, the chiplets 710 and 720 are reset and driven by the resetting-and-driving modules 712 and 722 respectively.

Then, the method proceeds to step S130, the chiplets 710 and 720 are identified by the classification modules 723 and 823 respectively through a serial number information. In the present step, the chiplet 710 can transmit its serial number information to the chiplet 720, and the chiplet 720 also transmits its serial number information to the chiplet 710. After receiving the serial number information from the chiplet 720, the chiplet 710 can obtain the size relationship between the serial number information of the chiplet 710 and the serial number information of the chiplet 720. After receiving the serial number information from the chiplet 710, the chiplet 720 can obtain the size relationship between the serial number information of the chiplet 710 and the serial number information of the chiplet 720. Based on the size relationship between the serial number information, classification can be performed.

Then, the method proceeds to step S140, a handshaking communication procedure is executed by the handshaking execution module 714 of the chiplet 710 and the handshaking execution module 724 of the chiplet 720 to confirm whether the pin connection relationship between the chiplets 710 and 720 is correct. If it is confirmed that the connection relationship between the chiplets 710 and 720 is incorrect, the method proceeds to step S150. If it is confirmed that the connection relationship between the chiplets 710 and 720 is correct, the method terminates. In step S140, the handshaking communication procedure can be executed in different ways.

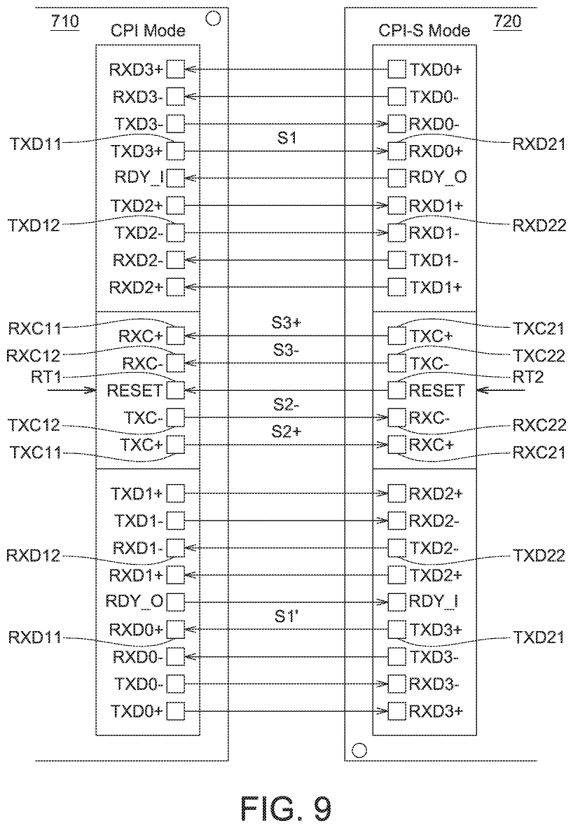

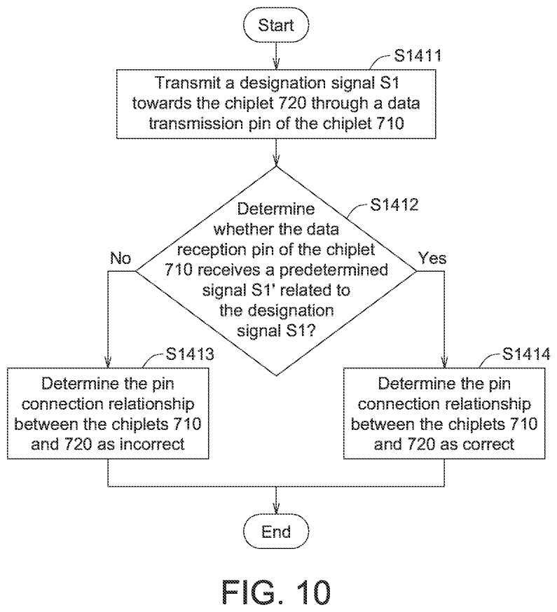

Referring to FIG. 9 and FIG. 10. FIG. 9 is a schematic diagram of the pins of chiplets 710 and 720 with an auto-swapping function according to an embodiment. FIG. 10 is a detailed flowchart of step S140 according to an embodiment. As indicated in FIG. 9, the pins of the first chiplet 710 symmetrically arranged on two sides of a reset pin RT1 of the first chiplet 710 have opposite functions. For instance, the data transmission pins TXD11 and TXD12 and the data reception pins RXD11 and RXD12 are symmetric with respect to the reset pin RT1. The pulse reception pins RXC11 and RXC12 and the pulse transmission pins TXC11 and TXC12 are symmetric with respect to the reset pin RT1. The pins of the second chiplet 720 symmetrically arranged on two sides of a reset pin RT2 of the second chiplet 720 have opposite functions. For instance, the data reception pins RXD21 and RXD22 and the data transmission pins TXD21 and TXD22 are symmetric with respect to the reset pin RT2. The pulse transmission pins TXC21 and TXC22 and the pulse reception pins RXC21 and RXC22 are symmetric with respect to the reset pin RT2.

The step S140 of FIG. 8 includes steps S1411 to S1414 of FIG. 10. In step S1411, a designation signal S1 is transmitted towards the chiplet 720 by the chiplet 710 through a particular data transmission pin of the chiplet 710 (such as data transmission pin TXD11).

Then, the method proceeds to step S1412 to S1414, whether the connection relationship between the chiplets 710 and 720 is correct is confirmed by the chiplet 710 through a data reception pin of the chiplet 710 (such as data reception pin RXD11). To put it in greater details, in step S1412, whether the data reception pin of the chiplet 710 (such as data reception pin RXD11) receives a predetermined signal S1′ related to the designation signal S1 is determined by the handshaking execution module 724 of the chiplet 710. If it is determined that the data reception pin (such as data reception pin RXD11) does not receive the predetermined signal S1′ related to the designation signal S1, the method proceeds to step S1413, the pin connection relationship between the chiplets 710 and 720 is determined as incorrect. If it is determined that the data reception pin (such as data reception pin RXD11) receives the predetermined signal S1′ related to the designation signal S1, the method proceeds to step S1414, the pin connection relationship between the chiplets 710 and 720 is determined as correct.

For instance, the designation signal S1 requests an inner code from the chiplet 720. If the received predetermined signal S1′ is exactly the requested inner code, this indicates that the pin connection relationship between the chiplets 710 and 720 is correct. If the received predetermined signal S1′ is not the inner code or even no information is received, this indicates that the pin connection relationship between the chiplets 710 and 720 is incorrect.

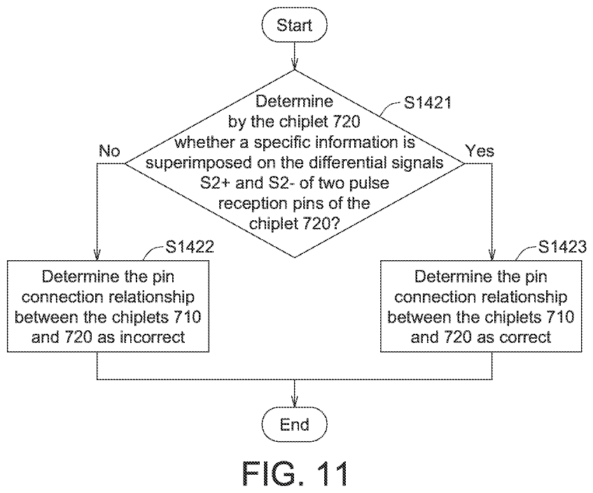

Referring to FIG. FIGS. 9 and 11. FIG. 11 is a detailed flowchart of step S140 according to an embodiment. The step S140 of FIG. 8 includes steps S1421 to S1423 of FIG. 11. In step S1421 to S1423, whether the connection relationship between the chiplets 710 and 720 is correct is confirmed by the chiplet 720 through the differential signals S2+ and S2− of two pulse reception pins of the chiplet 720 (such as pulse reception pins RXC21 and RXC22). To put it in greater details, in step S1421, whether a specific information is superimposed on the differential signals S2+ and S2− of two pulse reception pins of the chiplet 720 (such as pulse reception pins RXC21 and RXC22) is determined by the handshaking execution module 724 of the chiplet 720. If it is determined that the specific information is not superimposed on the differential signals S2+ and S2− of two pulse reception pins of the chiplet 720 (such as pulse reception pins RXC21 and RXC22), in step S1422, the pin connection relationship between the chiplets 710 and 720 is determined as incorrect. If it is determined that the specific information is superimposed on the differential signals S2+ and S2− of two pulse reception pins of the chiplet 720 (such as pulse reception pins RXC21 and RXC22), in step S1423, the pin connection relationship between the chiplets 710 and 720 is determined as correct.

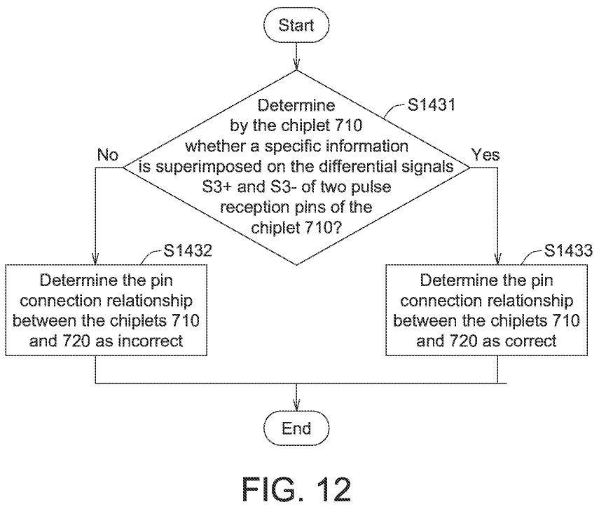

Referring to FIGS. 9 and 12. FIG. 12 is a detailed flowchart of step S140 according to an embodiment. Step S140 of FIG. 8 includes steps S1431 to S1433 of FIG. 12. In step S1431 to S1433, whether the connection relationship between the chiplets 710 and 720 is correct is confirmed by the chiplet 710 through the differential signals S3+ and S3− of two pulse reception pins of the chiplet 710 (such as pulse reception pins RXC11 and RXC12). To put it in greater details, in step S1431, whether a specific information is superimposed on the differential signals S3+ and S3− of two pulse reception pins of the chiplet 710 (such as pulse reception pins RXC11 and RXC12) is determined by the handshaking execution module 714 of the chiplet 710. If it is determined that the specific information is not superimposed on the differential signals S3+ and S3− of two pulse reception pins of the chiplet 710 (such as pulse reception pins RXC11 and RXC12), in step S1432, the pin connection relationship between the chiplets 710 and 720 is determined as incorrect. If it is determined that the specific information is superimposed on the differential signals S3+ and S3− of two pulse reception pins of the chiplet 710 (such as pulse reception pins RXC11 and RXC12), in step S1433, the pin connection relationship between the chiplets 710 and 720 is determined as correct.

Three implementations of step S140 are disclosed in FIG. 10, FIG. 11, FIG. 12. The three implementations can be implemented individually. In an embodiment, two of the three implementations can be adopted at the same time (that is, whether the pin connection relationship is correct needs to be determined in both implementations). In another embodiment, all of the three implementations can be adopted at the same time (that is, whether the pin connection relationship is correct needs to be determined in all of the three implementations).

In step S140 of FIG. 8, if it is determined that the pin connection relationship between the chiplets 710 and 720 is incorrect, the method proceeds to step S150. In step S150, pin function switching is performed by the chiplet 710 or the chiplet 720. In the present step, pin swapping function can be performed by one of the chiplets 710 and 720. Since the pin functions are symmetrically arranged, pin functions can be switched by swapping transmission function with reception function or the other way round.

In step S140 of FIG. 8, if it is determined that the pin connection relationship between the chiplets 710 and 720 is correct, the method terminates, and none of the chiplets 710 and 720 pin function switching.

According to the above embodiments, whether the connection relationship between the chiplets 710 and 720 is correct can be confirmed through a handshaking communication procedure. If the pin connection relationship between the chiplets 710 and 720 is incorrect, one of the chiplets can automatically perform pin function switching to assure that the chiplet system 700 can operate normally. Thus, the chiplet system can more flexibly connect the chiplets 710 and 720 in a side-by-side manner or a stacked manner. Moreover, the chiplets 710 and 720, despite being arranged in a wrong direction, the packaging process still can operate normally, and flexibility of the packaging process can be greatly increased.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A signal communication method of a chiplet system with an auto-swapping function, wherein the chiplet system at least comprises a first chiplet and a second chiplet, and the signal communication method comprises:
electrifying the first chiplet and the second chiplet;
resetting and driving the first chiplet and the second chiplet;
identifying the first chiplet and the second chiplet through a serial number information;
executing a handshaking communication procedure by the first chiplet and the second chiplet to confirm whether a pin connection relationship between the first chiplet and the second chiplet is correct; and
performing pin function switching on the first chiplet or the second chiplet if the pin connection relationship between the first chiplet and the second chiplet is incorrect.

2. The signal communication method of the chiplet system with the auto-swapping function according to claim 1, wherein the step of executing the handshaking communication procedure by the first chiplet and the second chiplet comprises:
transmitting a designation signal towards the second chiplet by the first chiplet through a data transmission pin of the first chiplet; and
confirming whether the pin connection relationship between the first chiplet and the second chiplet is correct by the first chiplet through a data reception pin of the first chiplet.

3. The signal communication method of the chiplet system with the auto-swapping function according to claim 2, wherein the first chiplet determines whether the data reception pin of the first chiplet receives a predetermined signal related to the designation signal to confirm whether the pin connection relationship between the first chiplet and the second chiplet is correct.

4. The signal communication method of the chiplet system with the auto-swapping function according to claim 1, wherein the step of executing the handshaking communication procedure by the first chiplet and the second chiplet comprises:
confirming whether the pin connection relationship between the first chiplet and the second chiplet is correct by the second chiplet through a differential signal of two pulse reception pins of the second chiplet.

5. The signal communication method of the chiplet system with the auto-swapping function according to claim 4, wherein the second chiplet determines whether a specific information is superimposed on the differential signal of the pulse reception pins of the second chiplet to confirm whether the pin connection relationship between the first chiplet and the second chiplet is correct.

6. The signal communication method of the chiplet system with the auto-swapping function according to claim 1, wherein the step of executing the handshaking communication procedure by the first chiplet and the second chiplet comprises:
confirming whether the pin connection relationship between the first chiplet and the second chiplet is correct by the first chiplet through a differential signal of two pulse reception pins of the first chiplet.

7. The signal communication method of a chiplet system with an auto-swapping function according to claim 6, wherein the first chiplet determines whether a specific information is superimposed on the differential signal of the pulse reception pins of the first chiplet to confirm whether the pin connection relationship between the first chiplet and the second chiplet is correct.

8. The signal communication method of the chiplet system with the auto-swapping function according to claim 1, wherein pins of the first chiplet symmetrically arranged on two sides of a reset pin of the first chiplet have opposite functions; pins of the second chiplet symmetrically arranged on two sides of a reset pin of the second chiplet have opposite functions.

9. The signal communication method of the chiplet system with the auto-swapping function according to claim 1, wherein the step of performing the pin function switching by the first chiplet or the second chiplet is not performed if the pin connection relationship between the first chiplet and the second chiplet is correct.

10. A chiplet system with an auto-swapping function, at least comprising:
a first chiplet, comprising:
a first electrification module used to perform electrification;
a first resetting-and-driving module used to perform resetting and driving;
a first classification module used to identify the first chiplet through a serial number information; and
a first handshaking execution module used to execute a handshaking communication procedure; and
a second chiplet, comprising:
a second electrification module used to perform electrification;
a second resetting-and-driving module used to perform resetting and driving;
a second classification module used to identify the second chiplet through the serial number information; and
a second handshaking execution module used to execute the handshaking communication procedure;
wherein the first chiplet and the second chiplet execute the handshaking communication procedure to confirm whether a pin connection relationship between the first chiplet and the second chiplet is correct; if the pin connection relationship between the first chiplet and the second chiplet is incorrect, the first handshaking execution module of the first chiplet or the second handshaking execution module of the second chiplet performs pin function switching.

11. The chiplet system with the auto-swapping function according to claim 10, wherein
the first handshaking execution module of the first chiplet transmits a designation signal towards the second chiplet through a data transmission pin of the first chiplet; and
the first handshaking execution module of the first chiplet confirms whether the pin connection relationship between the first chiplet and the second chiplet is correct through a data reception pin of the first chiplet.

12. The chiplet system with the auto-swapping function according to claim 11, wherein the first handshaking execution module of the first chiplet determines whether the data reception pin of the first chiplet receives a predetermined signal related to the designation signal to confirm whether the pin connection relationship between the first chiplet and the second chiplet is correct.

13. The chiplet system with an auto-swapping function according to claim 10, wherein the second handshaking execution module of the second chiplet confirms whether the pin connection relationship between the first chiplet and the second chiplet is correct through a differential signal of two pulse reception pins of the second chiplet.

14. The chiplet system with an auto-swapping function according to claim 13, wherein the second handshaking execution module of the second chiplet determines whether a specific information is superimposed on the differential signal of the pulse reception pins of the second chiplet to confirm whether the pin connection relationship between the first chiplet and the second chiplet is correct.

15. The chiplet system with an auto-swapping function according to claim 10, wherein the first handshaking execution module of the first chiplet confirms whether the pin connection relationship between the first chiplet and the second chiplet is correct through a differential signal of two pulse reception pins of the first chiplet.

16. The chiplet system with an auto-swapping function according to claim 15, wherein the first handshaking execution module of the first chiplet determines whether a specific information is superimposed on the differential signal of the pulse reception pins of the first chiplet to confirm whether the pin connection relationship between the first chiplet and the second chiplet is correct.

17. The chiplet system with an auto-swapping function according to claim 10, wherein if the pin connection relationship between the first chiplet and the second chiplet is correct, none of the first handshaking execution module of the first chiplet and the second handshaking execution module of the second chiplet performs the pin function switching.

18. A chiplet with an auto-swapping function, comprising:
an electrification module used to perform electrification;
a resetting-and-driving module used to perform resetting and driving; and
a handshaking execution module used to execute a handshaking communication procedure;
wherein the chiplet executes the handshaking communication procedure to confirm whether a pin connection relationship between the chiplet and other chiplet; if the pin connection relationship between the chiplet and the other chiplet is incorrect, the handshaking execution module performs pin function switching.

19. The chiplet with the auto-swapping function according to claim 18, wherein
the handshaking execution module of the chiplet transmits a designation signal towards the other chiplet through a data transmission pin; and
the handshaking execution module of the chiplet confirms whether the pin connection relationship between the chiplet and the other chiplet is correct through a data reception pin.

20. The chiplet with an auto-swapping function according to claim 18, wherein the handshaking execution module confirms whether the pin connection relationship between the chiplet and the other chiplet is correct through a differential signal of two pulse reception pins of the chiplet.
